(19) United States
(12) Patent Application Publication
(10) Pub. No.: US 2004/0012737 A1
(43) Pub. Date: Jan. 22, 2004

(54) Liquid crystal display device having contrast improved by preventing disturbance of liquid crystal orientation due to disturbance of electric field in applying voltage

(75) Inventor: Hiroyuki Hebiguchi, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/614,848

(22) Filed: Jul. 7, 2003

(30) Foreign Application Priority Data
Jul. 19, 2002 (JP) 2002-211391

(51) Int. Cl. G02F 1/1335

(52) U.S. Cl. 349/113

(57) ABSTRACT

A liquid crystal display device having a configuration in which a liquid crystal is held between a pair of substrates arranged facing each other, on a lower substrate, a plurality of scanning lines and a plurality of data lines are provided in the matrix while a diffusion reflector doubling as a display electrode and a thin film transistor connected to the diffusion reflector are provided in each of regions partitioned by the scanning lines and the data lines, a common electrode is provided under an upper substrate, the diffusion reflector is composed of a specular reflector having electrical conductivity and a light-diffusion portion made of a transparent dielectric arranged on the specular reflector, and the light-diffusion portion has an uneven configuration on the surface in the side facing the liquid crystal.

### BACKGROUND OF THE INVENTION

1. Field of the Invention

The present invention relates to a liquid crystal display device.

2. Description of the Related Art

In general, display modes of liquid crystal display devices include the types referred to as a transflective type and a transmissive type, provided with backlights, and the type referred to as a reflective type. The reflective liquid crystal display device is a liquid crystal display device which performs display by simply using external light, e.g. sunlight and illumination light, with no backlight, and has been often used for, e.g. portable data terminals in which low profile, reduction in weight and low power consumption are required. The transflective liquid crystal display device is operated in the transmissive mode while the backlight stays on under circumstances where external light is not sufficiently available, is operated in the reflective mode while the backlight stays off under circumstances where external light is sufficiently available, and therefore, has been often used for portable electronic equipment, e.g. cellular phones and notebook personal computers.

A liquid crystal display device shown in FIG. 3 is known as a conventional reflective liquid crystal display device.

In this reflective liquid crystal display device, a liquid crystal layer 115 is held between a pair of glass substrates 113 and 114.

A plurality of scanning lines (not shown in the drawing) and a plurality of data lines (not shown in the drawing) are provided in the matrix on the lower glass substrate 113, and an uneven reflector 125 doubling as a pixel electrode and an amorphous silicon thin film transistor (a-SiTFT) 126 connected to this uneven reflector 125 are provided in each of regions partitioned by these scanning lines and the data lines. The uneven reflector 125 doubling as a pixel electrode is made of a metal film, and has an uneven configuration on the surface thereof. The (a-SiTFT) 126 has a configuration in which a gate insulating layer 130 is formed on a gate electrode 129 led out of the scanning line and arranged, an a-Si semiconductor layer 131 is provided on this gate insulating layer 130, and a source electrode 127 and a drain electrode 128 are further formed on this semiconductor layer 131. An interlayer insulating layer 132 having an uneven configuration on the surface is formed in order to cover these a-SiTFT 126 and drain electrode 128, and the above-mentioned uneven reflector 125 is formed on this interlayer insulating layer 132. A contact hole 132a is formed in this interlayer insulating layer 132, and the drain electrode 128 and the uneven reflector 125 are connected through this contact hole 132a. An alignment film (not shown in the drawing) is formed in order to cover these uneven reflector 125 and interlayer insulating layer 132.

On the other hand, a color filter layer 123, a common electrode 124 and an alignment film (not shown in the drawing) are successively formed in that order under the upper glass substrate 114.

In this conventional reflective liquid crystal display device, projections and depressions are provided on the surface of the reflector 125 itself in order to impart the diffusion property, as described above. On the other hand, this uneven reflector 125 doubles as a pixel electrode (display electrode) for applying a signal voltage to the liquid crystal. Consequently, when a signal voltage is applied to this uneven reflector 125, disturbance of the electric field occurs due to the uneven configuration of the surface of this reflector 125. Since this disturbance of the electric field occurs in the surface of the reflector 125 doubling as a pixel electrode, the display is adversely affected. In particular, in the case where display is performed in the normally white mode in which the white display is performed in applying no voltage, and the black display is performed in applying the voltage, the electric field is disturbed in the black display, and thereby, problems occur in that the orientation of the liquid crystal is disturbed, the black display is not sufficiently darkened, and the contrast is reduced.

### SUMMARY OF THE INVENTION

The present invention was made in consideration of the above-mentioned circumstances. Accordingly, it is an object of the present invention to provide a liquid crystal display device provided with a reflector doubling as a display electrode, wherein disturbance of the liquid crystal orientation due to disturbance of the electric field is prevented, and the contrast is improved.

In order to overcome the above-mentioned problems, with respect to a liquid crystal display device of the present invention, a liquid crystal is held between a pair of substrates arranged facing each other, on one substrate of a pair of the above-mentioned substrates, a plurality of scanning lines and a plurality of data lines are provided in the matrix while a diffusion reflector doubling as a display electrode and a switching element connected to the diffusion reflector are provided in each of regions partitioned by the scanning lines and the data lines, and a counter electrode is provided under the other substrate, wherein the above-mentioned diffusion reflector is composed of a specular reflector having electrical conductivity and a light-diffusion portion made of a transparent dielectric arranged on the specular reflector, and the light-diffusion portion has an uneven configuration on the surface in the side facing the liquid crystal.

According to the above-mentioned configuration, since the surface, in the side facing the liquid crystal, of the specular reflector provided on the diffusion reflector is a specular surface, the reflection property can be provided, and this specular reflector can double as a display electrode because of having electrical conductivity. This specular reflector itself having a surface with no projection nor depression in the side facing the liquid crystal, and therefore, has a flat surface. Consequently, even when a signal voltage is applied, disturbance of the electric field in this display electrode can be prevented, disturbance of the liquid crystal orientation due to the disturbance of the electric field in applying the voltage can be prevented, and a liquid crystal display device having the improved contrast can be achieved. In particular, in the case where display is performed in the normally white mode, disturbance of the electric field in the black display can be prevented, and thereby, disturbance of the liquid crystal orientation can be prevented, the black display can be sufficiently darkened, and the contrast can be improved.

Even when the surface of the reflector is thus adjusted to be a specular surface, since a light-diffusion portion having the surface with an uneven configuration is provided in the side facing the liquid crystal of this specular reflector, as described above, sufficient light-diffusion property can be provided. Furthermore, since this light-diffusion portion is formed from a dielectric rather than a conductor, even when the surface in the side facing the liquid crystal has an uneven configuration, no energization occurs in applying the voltage, and therefore, the electric field is not significantly disturbed.

Consequently, according to the liquid crystal display device of the present invention, disturbance of the electric field in applying the voltage can be reduced, and the contrast can be improved compared with that in a conventional liquid crystal display device in which projections and depressions are formed on the surface of the reflector itself doubling as a display electrode.

A thin film transistor or a thin film diode can be used as the above-mentioned switching element.

In the present specification, “in applying no voltage” and “in applying the voltage” refer to “when the voltage applied to a liquid crystal layer is less than the threshold voltage of the liquid crystal” and “when the voltage applied to a liquid crystal layer is more than or equal to the threshold voltage of the liquid crystal” respectively.

The above-mentioned problems can also be overcome by a liquid crystal display device, in which a liquid crystal is held between a pair of substrates arranged facing each other, a diffusion reflector doubling as a display electrode is provided on one substrate of a pair of the above-mentioned substrates, and a counter electrode intersecting the above-mentioned display electrode is provided under the other substrate, wherein the above-mentioned diffusion reflector is composed of a specular reflector having electrical conductivity and a light-diffusion portion made of a transparent dielectric arranged on the specular reflector, and the light-diffusion portion has an uneven configuration on the surface in the side facing the liquid crystal.

According to the liquid crystal display device having such a configuration as well, effects similar to that of the liquid crystal display device having the configuration described above can be achieved.

Here, that a counter electrode intersects the above-mentioned display electrode refers to that a counter electrode seems to intersect the above-mentioned display electrode when this liquid crystal display device is viewed from the one or the other substrate side (in the plan view).

The above-mentioned light-diffusion portion may be composed of a number of projections arranged at a distance from each other.

The above-mentioned light-diffusion portion may be provided by forming projections and depressions on the surface, in the side facing the liquid crystal, of the layer made of a transparent dielectric.

As the above-mentioned liquid crystal, a TN (Twisted Nematic) type is often used in an active matrix type, and an STN (Super Twisted Nematic) type is often used in a passive matrix type. In both of the TN type and the STN type, an angle of twist of a molecule in applying the voltage is different from that in applying no voltage, and thereby, a value of dielectric constant of the liquid crystal in applying the voltage is different from that in applying no voltage.

In the present invention, preferably, the value of dielectric constant of the transparent dielectric constituting the above-mentioned light-diffusion portion is close to the value of dielectric constant of the above-mentioned liquid crystal in applying the voltage to the liquid crystal rather than the value of dielectric constant of the above-mentioned liquid crystal in applying no voltage to the liquid crystal. According to such a configuration, in the black display, an effect of reducing disturbance of the electric field which occurs due to the difference between the value of dielectric constant of the above-mentioned transparent dielectric and the value of dielectric constant of the liquid crystal in applying the voltage can be improved, and furthermore, the contrast can be improved.

In the present invention, preferably, the value of refractive index of the transparent dielectric constituting the above-mentioned light-diffusion portion is close to the value of refractive index of the above-mentioned liquid crystal in applying the voltage to the liquid crystal rather than the value of refractive index of the above-mentioned liquid crystal in applying no voltage to the liquid crystal. According to the above-mentioned configuration, in the white display in which the diffusion property is required, since the difference between the value of refractive index of the transparent dielectric and the value of refractive index of the liquid crystal in applying no voltage can be increased, the function of diffusion can be effectively achieved, and the white display becomes brighter. On the other hand, in the black display, since the difference between the value of refractive index of the transparent dielectric and the value of refractive index of the liquid crystal in applying the voltage can be decreased, the diffusion can be reduced to a low level, the black display can be further darkened, and thereby, the contrast can be further improved.

In the present invention, preferably, a maximum value of the thickness of the above-mentioned light-diffusion portion is 3 μm or less. If the maximum value of the thickness of the light-diffusion portion exceeds 3 μm, the loss of voltage applied to the liquid crystal is increased, and sticking is likely to occur.

In the present invention, the transparent dielectric constituting the above-mentioned light-diffusion portion may be made of polyimide. When the transparent dielectric is constructed from polyimide, the transparent dielectric can be further provided with a function as an alignment film by being subjected to a rubbing treatment.

In the present invention, the above-mentioned diffusion reflector can serve as a transflector by forming a hole in the above-mentioned specular reflector, reducing the thickness, or the like.

As described above, according to the present invention, the liquid crystal display device can be provided in which the disturbance of the liquid crystal orientation due to disturbance of the electric field in applying the voltage is prevented, and the contrast is improved.

### BRIEF DESCRIPTION OF THE DRAWINGS

FIG. 1 is a two-dimensional configuration diagram showing an embodiment of a reflective liquid crystal display device according to the present invention.

FIG. 2 is a sectional configuration diagram along the line II-II shown in FIG. 1.

FIG. 3 is a sectional view showing an example of a conventional liquid crystal display device.

### DESCRIPTION OF THE PREFERRED EMBODIMENTS

The case where the liquid crystal display device of the present invention is applied to an active matrix type reflective liquid crystal display device will be described below. However, the present invention is not limited to the following embodiments.

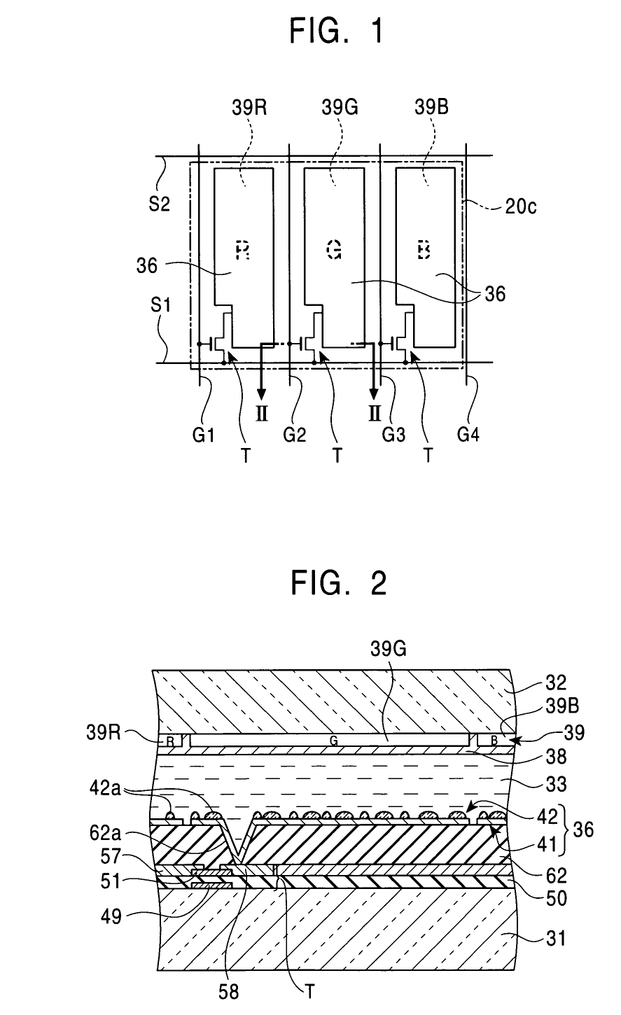

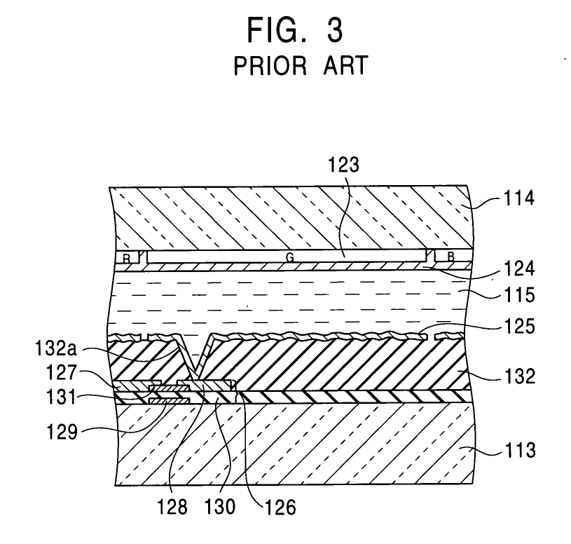

A two-dimensional configuration diagram of a reflective liquid crystal display device of the present embodiment is shown in FIG. 1, and a sectional configuration diagram along the line II-II shown in FIG. 1 is shown in FIG. 2.

The reflective liquid crystal display device shown in FIG. 1 and FIG. 2 has a configuration in which a liquid crystal layer 33 is held between a lower substrate (one substrate) 31 and an upper substrate (the other substrate) 32, which are arranged facing each other.

A plurality of substantially rectangular diffusion reflectors 36 doubling as pixel electrodes (display electrodes), which are arranged in the matrix in the plan view, and thin film transistors (switching elements) T for pixel switching, which are arranged on a diffusion reflector 36 basis, are provided on the lower substrate 31 (in the interior side, in the side facing the liquid crystal). In FIG. 1, the thin film transistor T is indicated by an equivalent circuit diagram to facilitate understanding the diagram.

The diffusion reflector 36 is composed of a specular reflector 41 and a light-diffusion portion 42 formed on this specular reflector 41 (in the side facing the liquid crystal), and the light-diffusion portion 42 has an uneven configuration on the surface in the side facing the liquid crystal.

The specular reflector 41 is made of a material, e.g. Al, an Al alloy, Ag or an Ag alloy, having electrical conductivity and light-reflection property. The specular reflector 41 is thus constructed from a material having light-reflection property and electrical conductivity, and therefore, can perform both functions as a reflector and a pixel electrode.

The light-diffusion portion 42 is provided in order to diffuse the light when the light incident into the liquid crystal display device is reflected at the diffusion reflector 36, and has a configuration in which a number of projections 42 a are arranged at a distance from each other on the specular reflector 41. The material of this light-diffusion portion 42 is a transparent dielectric, and specifically, the material to be used is appropriately selected from organic materials of, e.g. acryl-based, polystyrene-based or polyimide-based, or inorganic materials, e.g. Si₃N₄. Since the light-diffusion portion 42 is made of the transparent dielectric, as described above, no energization occur in applying the voltage.

Preferably, the maximum value of the thickness of the light-diffusion portion 42 is 3 μm or less because of the reason described above.

Preferably, the above-mentioned many projections 42a are irregularly arranged.

Preferably, (condition 1) the value of dielectric constant ε of the transparent dielectric constituting the light-diffusion portion 42 is close to the value of dielectric constant ε_{B} of the above-mentioned liquid crystal in applying the voltage to the liquid crystal (put another way, in the black display when display is performed in the normally white mode) rather than the value of dielectric constant ε_{W} of the above-mentioned liquid crystal in applying no voltage to the liquid crystal (put another way, in the white display).

Preferably, (condition 2) the value of refractive index n of the transparent dielectric constituting the light-diffusion portion 42 is close to the value of refractive index n_{B} of the above-mentioned liquid crystal in applying the voltage to the liquid crystal (put another way, in the black display) rather than the value of refractive index n_{W} of the above-mentioned liquid crystal in applying no voltage to the liquid crystal (put another way, in the white display).

More preferably, the transparent dielectric constituting the light-diffusion portion 42 satisfies both of the above-mentioned conditions 1 and 2.

When the above-mentioned light-diffusion portion 42 is constructed from the above-mentioned organic materials, examples of formation methods therefor include, for example, a method in which a number of projections 42a are formed on the above-mentioned specular reflector 41 by a printing method of screen printing, offset printing or the like, and a method in which a coating of a photosensitive resin is applied on the above-mentioned specular reflector 41 by a spin coating method or the like, and thereafter, exposure and development are performed using a photomask so as to form a number of projections 42a.

The thin film transistor T has a configuration in which a gate insulating layer 50 is formed on a gate electrode 49 formed on the substrate 31, an a-Si semiconductor layer 51 is provided on this gate insulating layer 50, and a source electrode 57 and drain electrode 58 are further formed on this semiconductor layer 51.

An interlayer insulating layer 62 is formed in order to cover these thin film transistor T and the gate insulating layer 50, and the above-mentioned diffusion reflector 36 is formed on this interlayer insulating layer 62. A contact hole 62a is formed in this interlayer insulating layer 62, and the drain electrode 58 and the specular reflector 41 doubling as a pixel electrode are connected through this contact hole 62a.

As shown in FIG. 1, the gate electrodes 49 of the thin film transistors T are connected to scanning lines G1 to G3 successively arranged, in the horizontal direction in the drawing, between the diffusion reflectors 36 (in particular, between the specular reflectors 41 ), and the source electrodes 57 are connected to a data line (signal line) S1, while the data lines are successively arranged in the vertical direction in the drawing.

An alignment film (not shown in the drawing) is formed in order to cover the diffusion reflector 36 and the interlayer insulating layer 62.

A color filter layer 39 and a transparent common electrode (counter electrode) 38, which is formed substantially all over the bottom surface of the color filter layer 39 and which is made of indium tin oxide (hereafter abbreviated as ITO) or the like, are provided under the upper substrate 32 (in the interior side, in the side facing the liquid crystal). An alignment film (not shown in the drawing) is formed in order to cover this common electrode 38.

The color filter layer 39 is provided with a coloring portion 39R for red R, a coloring portion 39G for green G and a coloring portion 39B for blue B in the locations corresponding to respective diffusion reflectors 36 on the lower substrate 31 and a black matrix (not shown in the drawing) is arranged in the shape of a lattice in the plan view between the adjacent coloring portions. A region, in which three diffusion reflectors 36 corresponding to respective coloring portions constituting the color filter layer 39 are formed, is corresponding to one pixel 20c.

Although not shown in the drawing, a black matrix in the shape of a lattice in the plan view is also formed in the interior side of the lower substrate 31 in order to surround the diffusion reflectors 36, so that the light incident from the upper surface side does not incident into the thin film transistors T and scanning lines and data lines connected thereto.

The reflective liquid crystal display device having the above-mentioned configuration performs display by controlling the potential of the specular reflector 41 doubling as a pixel electrode with the thin film transistor T, and controlling the light-transmission state of the liquid crystal layer 33 located between the specular reflector 41 and the common electrode 38 of the upper substrate 32.

In the reflective liquid crystal display device of the present embodiment, since the diffusion reflector 36 is composed of the specular reflector 41 having electrical conductivity and the light-diffusion portion 42 made of the transparent dielectric arranged on the specular reflector 41, the above-mentioned specular reflector 41 itself has no projection nor depression on the surface in the side facing the liquid crystal, and is a flat surface. Therefore, even when a signal voltage is applied, disturbance of the electric field in this display electrode can be reduced, disturbance of the liquid crystal orientation due to disturbance of the electric field in applying the voltage can be prevented, and the liquid crystal display device having the improved contrast can be achieved. Since the light-diffusion portion 42 having an uneven configuration on the surface is provided on the specular reflector 41, as described above, sufficient light-diffusion property can be provided. Consequently, according to the reflective liquid crystal display device of the present embodiment, disturbance of the electric field in applying the voltage can be reduced, and the contrast can be improved compared with that in a conventional liquid crystal display device in which projections and depressions are formed on the surface of the reflector itself doubling as a display electrode.

In the present embodiment, the case where the alignment film was provided in the lower substrate 31 side separately from the light-diffusion portion 42 was described. However, when the transparent dielectric constituting the light-diffusion portion 42 is constructed from polyimide, the light-diffusion portion 42 and the alignment film may not be separately provided because this transparent dielectric can also be provided with a function as an alignment film by being subjected to a rubbing treatment.

In the present embodiment, the case where the light-diffusion portion 42 was composed of a number of projections 42a arranged at a distance from each other was described. However, it is only essential that the projections and depressions are arranged on at least the surface in the side facing the liquid crystal, the projections and depressions may be arranged on the surface, in the side facing the liquid crystal, of a layer composed of a transparent dielectric.

In the present embodiment, the case where the liquid crystal display device of the present invention was applied to the active matrix type liquid crystal display device was described. However, it can also be applied to a passive matrix type liquid crystal display device in which a liquid crystal is held between a pair of substrates arranged facing each other, a diffusion reflector doubling as a display electrode is provided on one substrate of a pair of the above-mentioned substrates, and a counter electrode intersecting the above-mentioned display electrode is provided under the other substrate. In that case, the above-mentioned diffusion reflector to be used is composed of a specular reflector having electrical conductivity and a light-diffusion portion made of a transparent dielectric arranged on the specular reflector, while the light-diffusion portion has an uneven configuration on the surface in the side facing the liquid crystal.

In the present embodiment, the case where the liquid crystal display device of the present invention was applied to the reflective liquid crystal display device was described. However, the diffusion reflector 36 can serve as a transflector by forming a hole in the specular reflector 41, reducing the thickness, or the like. In that case, a transflective liquid crystal display device can also be achieved by providing a backlight below the lower substrate 31.

### EXAMPLES

The present invention will be further specifically described with reference to an example and a comparative example. However, the present invention is not simply limited to the example.

### Example

A reflective liquid crystal display device similar to that shown in FIG. 1 and FIG. 2 was prepared except that the material for the light-diffusion portion was adjusted to be Si₃N₄. The contrast of this reflective liquid crystal display device in the black display (in applying the voltage) was examined resulting in 40 or more. The refractive indices and the dielectric constants of the liquid crystal in the white display (in applying no voltage) and in the black display (in applying the voltage) are collectively shown in Table 1. The refractive index and the dielectric constant of the light-diffusion portion made of Si₃N₄ are also shown in Table 1.

### Comparative Example

As Comparative example, a reflective liquid crystal display device similar to that in Example 1 was prepared except that the material for the light-diffusion portion was adjusted to be SiO₂. The contrast of the reflective liquid crystal display device of Comparative example in the black display (in applying the voltage) was examined resulting in 20 or less (in the range of 10 to 15). The refractive index and the dielectric constant of the light-diffusion portion made of SiO₂ are also shown in Table 1.

TABLE 1

| | | | | SiO₂ Light- |
|---|---|---|---|---|
| | Liquid | Liquid | Si₃N₄ Light- | diffusion |
| | crystal | crystal | diffusion | portion |
| | in white | in black | portion | (Comparative |
| | display | display | (Example) | example) |
| Refractive | 1.475 | 1.54 | 2.05 | 1.46 |
| index | | | | |
| Dielectric | 3.8 | 9.5 | 7.5 | 3.9 |
| constant | | | | |

As is clear from the measurement results of the contrast in the black display, the contrast of the display device of Example is excellent compared with that of the display device of Comparative example.

As shown in the above-mentioned Table 1, in the reflective liquid crystal display device of Comparative example, the difference between the value of the dielectric constant of the light-diffusion portion and the value of the dielectric constant of the liquid crystal in the black display is 5.6, and the value of the dielectric constant of the light-diffusion portion is close to the value of the dielectric constant of the liquid crystal in the white display rather than the value of the dielectric constant of the liquid crystal in the black display. Furthermore, in the display device of Comparative example, it is clear that the difference between the value of the refractive index of the light-diffusion portion and the value of the refractive index of the liquid crystal in the white display is 0.015, and the value of the refractive index of the light-diffusion portion is close to the value of the refractive index of the liquid crystal in the white display rather than the value of the refractive index of the liquid crystal in the black display.

On the other hand, in the reflective liquid crystal display device of Example, it is clear that the difference between the value of the dielectric constant of the light-diffusion portion and the value of the dielectric constant of the liquid crystal in the black display is 2.0, and the value of the dielectric constant of the light-diffusion portion is close to the value of the dielectric constant of the liquid crystal in the black display rather than the value of the dielectric constant of the liquid crystal in the white display. In this manner, with respect to the display device of Example, the difference between the value of the dielectric constant of the light-diffusion portion and the value of the dielectric constant of the liquid crystal in applying the voltage is smaller than that of the display device of Comparative example, and therefore, it is believed that the effect is exerted on reduction of the disturbance of the electric field caused by the difference between the value of the dielectric constant of the above-mentioned transparent dielectric and the value of the dielectric constant of the liquid crystal in applying the voltage, and the contrast can be improved.

Furthermore, in the display device of Example, it is clear that the difference between the value of the refractive index of the light-diffusion portion and the value of the refractive index of the liquid crystal in the white display is 0.575, and the value of the refractive index of the light-diffusion portion is close to the value of the refractive index of the liquid crystal in the black display rather than the value of the refractive index of the liquid crystal in the white display. In this manner, with respect to the display device of Example, in the white display, the difference between the value of the refractive index of the light-diffusion portion and the value of the refractive index of the liquid crystal in the white display can be increased compared with that of the display device of Comparative example, and therefore, it is believed that the diffusion function can be effectively achieved, and the white display can be made brighter. On the other hand, in the black display, the difference between the value of the refractive index of the light-diffusion portion and the value of the refractive index of the liquid crystal in the black display can be decreased compared with that of the display device of Comparative example, and therefore, it is believed that the disturbance of the electric field can be reduced to a lower level, the black display can be further darkened, and the contrast can be improved.

What is claimed is:

1. A liquid crystal display device in which a liquid crystal is held between a pair of substrates arranged facing each other, on one substrate of a pair of the substrates, a plurality of scanning lines and a plurality of data lines are provided in the matrix while a diffusion reflector doubling as a display electrode and a switching element connected to the diffusion reflector are provided in each of regions partitioned by the scanning lines and the data lines, and a counter electrode is provided under the other substrate,
wherein the diffusion reflector comprises a specular reflector having electrical conductivity and a light-diffusion portion made of a transparent dielectric arranged on the specular reflector, and the light-diffusion portion has an uneven configuration on the surface in the side facing the liquid crystal.

2. The liquid crystal display device according to claim 1, wherein the light-diffusion portion comprises a number of projections arranged at a distance from each other.

3. The liquid crystal display device according to claim 1, wherein the value of the dielectric constant of the transparent dielectric constituting the light-diffusion portion is close to the value of the dielectric constant of the liquid crystal in applying the voltage to the liquid crystal rather than the value of the dielectric constant of the liquid crystal in applying no voltage to the liquid crystal.

4. The liquid crystal display device according to claim 1, wherein the value of the refractive index of the transparent dielectric constituting the light-diffusion portion is close to the value of the refractive index of the liquid crystal in applying the voltage to the liquid crystal rather than the value of the refractive index of the liquid crystal in applying no voltage to the liquid crystal.

5. The liquid crystal display device according to claim 1, wherein a maximum value of the thickness of the light-diffusion portion is 3 μm or less.

6. The liquid crystal display device according to claim 1, wherein the transparent dielectric constituting the light-diffusion portion comprises polyimide, and the transparent dielectric is subjected to a rubbing treatment so that a function as an alignment film is provided.

7. The liquid crystal display device according to claim 1, wherein the diffusion reflector is a transflector.

8. A liquid crystal display device in which a liquid crystal is held between a pair of substrates arranged facing each other, a diffusion reflector doubling as a display electrode is provided on one substrate of a pair of the substrates, and a counter electrode intersecting the display electrode is provided under the other substrate,
wherein the diffusion reflector comprises a specular reflector having electrical conductivity and a light-diffusion portion made of a transparent dielectric arranged on the specular reflector, and the light-diffusion portion has an uneven configuration on the surface in the side facing the liquid crystal.

9. The liquid crystal display device according to claim 8, wherein the light-diffusion portion comprises a number of projections arranged at a distance from each other.

10. The liquid crystal display device according to claim 8, wherein the value of the dielectric constant of the transparent dielectric constituting the light-diffusion portion is close to the value of the dielectric constant of the liquid crystal in applying the voltage to the liquid crystal rather than the value of the dielectric constant of the liquid crystal in applying no voltage to the liquid crystal.

11. The liquid crystal display device according to claim 8, wherein the value of the refractive index of the transparent dielectric constituting the light-diffusion portion is close to the value of the refractive index of the liquid crystal in applying the voltage to the liquid crystal rather than the value of the refractive index of the liquid crystal in applying no voltage to the liquid crystal.

12. The liquid crystal display device according to claim 8, wherein a maximum value of the thickness of the light-diffusion portion is 3 μm or less.

13. The liquid crystal display device according to claim 8, wherein the transparent dielectric constituting the light-diffusion portion comprises polyimide, and the transparent dielectric is subjected to a rubbing treatment so that a function as an alignment film is provided.

14. The liquid crystal display device according to claim 8, wherein the diffusion reflector is a transflector.
